(19) United States
(12) Patent Application Publication
(10) Pub. No.: US 2026/0365528 A1
(43) Pub. Date: Nov. 19, 2026

(54) METHOD FOR PRODUCTION OF BLUE AMMONIA

(71) Applicant: TOPSOE A/S, Kgs. Lyngby (DK)

(72) Inventors: Annette E. KRØLL JENSEN, Fredensborg (DK); Per Aggerholm SØRENSEN, Kgs. Lynby (DK)

(73) Assignee: TOPSOE A/S, Kgs. Lyngby (DK)

(21) Appl. No.: 19/154,469

(22) PCT Filed: Feb. 20, 2024
(86) PCT No.: PCT/EP2024/054248

§ 371 Date: Aug. 7, 2025

(30) Foreign Application Priority Data
Feb. 21, 2023 (DK) PA202300155

(51) Int. Cl. C01C 1/04; C01B 3/38

(52) U.S. Cl. CPC C01C 1/0405; C01B 3/38

(57) ABSTRACT

The present invention provides a method and system for producing blue ammonia, providing for a higher percentage of carbon capture. The method and system of the invention may be used in any ammonia plant.

### FIELD OF INVENTION

The present invention provides a method and plant for producing blue ammonia, providing for a high percentage of carbon capture. The method and system of the invention may be used in any ammonia plant.

### BACKGROUND ART

Blue ammonia is a fossil fuel-based product produced with minimum emission of CO₂ to the atmosphere. It is seen as a transition product between conventional fossil fuel-based ammonia and green ammonia produced from green or renewable power and air. The CO₂ resulting from a blue ammonia production shall be stored permanently or converted into other chemicals. The main steps for producing blue ammonia are essentially the same as for producing conventional fossil fuel-based ammonia, the difference being that more of the carbon stemming from the carbon fuel is captured, providing a possibility for further processing.

The key here is that the blue ammonia does not release any carbon dioxide when used as fertilizer or burned. Currently available technology traps nearly all CO₂ generated during the conversion process making this fuel one of the first carbon free fuel options for mass use. Blue ammonia is considered an environmental friendly product which can be used until sufficient renewable or green power is available for producing green ammonia.

Document WO2018/149641 discloses a process for the synthesis of ammonia from natural gas comprising conversion of a charge of desulphurized natural gas and steam, with oxygen-enriched air or oxygen, into a synthesis gas (11), and treatment of the synthesis gas (11) with shift reaction and decarbonation, wherein a part of the CO₂-depleted synthesis gas, obtained after decarbonation, is separated and used as fuel fraction for one or more furnaces of the conversion section, and the remaining part of the gas is used to produce ammonia.

In Document DK PA 2022 00424, off-gases from different process steps are utilized as fuel in a preheating system with between one and a number of fired heaters for preheating a hydrocarbon feed stock together with carbon capture from at least one heater, which enables the use of a more carbon rich fuel, thereby achieving a higher carbon capture (more than 98%) compared to the prior art.

We know we can capture over 60% of the CO₂ from a natural gas-based ammonia plant because this is in the process gas (the byproduct of hydrogen production). Many ammonia plants already utilize this CO₂ stream to produce urea or to sell as food grade CO₂. The remaining CO₂ emissions are in the much more dilute flue gas (the product of fuel combustion to preheat process streams). For some decades we have assumed we could capture most of this but the lingering question has always been: how much of that CO2 in the flue gas is economically feasible to capture?

To meet net-zero targets, the CO₂ capture rate should be as high as economically viable and as close to 100% as technically possible. However, a capture rate of 100% is still very challenging with an absorption-based system and residual emissions will need to be indirectly captured by CDR. In the present invention, flue gas carbon capture using a CDR is an absorption based and amine solvent based technology. The economic viability will further limit the capture rate to the range of 90-99%. In other words, it would be easier to capture that final one percent from air, as opposed to trying to capture it directly from the processed flue gas.

The present invention provides an economical way to achieve a high percentage of carbon capture of at least 98% wt.

### SUMMARY OF INVENTION

The present invention provides a method, system and plant for producing ammonia with a high percentage of carbon capture, preferably more than 98% wt, when compared to the prior art, where optimally between about 90-93% wt of carbon capture is achieved. An ammonia plant within the scope of the present invention maybe be revamped or a new plant for production of ammonia. A revamped plant is an existing or traditional plant for production of ammonia where changes are made in order to, e.g. improve its operation, performance, economy or carbon emissions. Furthermore, the fuel section comprises a reforming waste heat section (WHS)—FIGS. 2a) and 3—or one or more fired heaters—FIG. 2b)—wherein at least one of said fired heaters or reforming WHS is equipped with a CDR unit which captures 80% wt (or 80% vol) or more of CO₂ from the resulting flue gas. This translates into an overall carbon capture efficiency of at least 98% wt.

Utility prices vary depending on plant/site location. For given specific utility prices it variates which blue ammonia layout becomes the most optimal and attractive. The present invention provides a beneficial alternative, when compared to a similar layout without HTER, when the natural gas price increases and/or power price reduces (Table 1 and FIG. 4).

The method of the present invention provides the following advantages:
Can be applied for grass root plants and as revamps;
Utilize the already available CO₂ capture step in the ammonia process to perform the complete CO₂ capture;
Enables >98% wt CO₂ capture;
Lower cost of operations, particularly when the natural gas price increases and/or power price reduces (Table 1 and FIG. 4);
Reduces the amount of flue gas thus reducing the NOx formations and thereby the NOx emission to the atmosphere.

Said advantages are provided by a set of features, comprising:
The reforming step comprises heat exchange reforming, by connecting an HTER to the reforming section; and
Reformed gas or process gas collected out of a secondary reformer (2-step reforming) or out of an ATR (e.g in Syncor Ammonia™) is processed in the heat exchange reforming step where at least part of the carried heat is used.

### DESCRIPTION OF THE INVENTION

Reducing CO₂ emission has become a bound task in the chemical industry. Production of ammonia using hydrocarbons as feedstock inevitably results in CO₂ formation which typically ends up in at least two CO₂ containing process streams, one almost pure CO₂ stream (1) extracted from the syngas cleaning section and one or more flue gas streams (2). The CO₂ stream (1) can be utilized for further chemical processing or stored. The CO₂ in the flue gas stream(s) (2) needs to be captured before it can find similar use.

It is well known that CO₂ in the flue gas can be avoided by using carbon free fuels. In general hydrocarbons such as natural gas and carbon containing off gases originating from the process are used as fuels. A post combustion carbon capture or recovery unit, a flue gas CDR is applied for reducing the CO₂ in the remaining flue gas. One main advantage of this invention is that an HTER is connected to two-step reforming (FIGS. 2a and 3) or to an ATR (FIG. 2b) reducing the amount of flue gas, thereby reducing the CO₂ content in the streams, reducing cost of operation in the ammonia plant.

### DEFINITIONS

Autothermal Reforming (ATR) is the combined process of steam reforming and partial oxidation, a promising technology for low-cost and high-reliability hydrogen production. Compared to steam reforming, it is easier to operate with a smaller system, better temperature control, lower energy requirements, easier start-up, and less coking. In ATR, the reaction takes place in a single chamber where methane is partially oxidized. The reaction is exothermic due to the oxidation. The main difference between autothermal reforming and steam-methane reforming is that steam-methane reforming does not use or require oxygen. However, a major drawback of autothermal reforming is the large investment needed for an oxygen production plant, which simply becomes cost-effective only at high production capacities. Although air can be directly used instead of oxygen, the presence of inert nitrogen causes large gas volume and the system, therefore, requires larger equipment.

Generally, the autothermal reforming process is operated under adiabatic conditions and the product composition as well as the reaction temperature is governed by various operating parameters, e.g., preheat temperature of fuel, water, and air, pressure, fuel composition, heat loss, steam-to-carbon ratio, and air-to-carbon ratio. The suitable fuel for autothermal reforming is highly flexible, such as several gaseous hydrocarbons, e.g., methane, natural gas, LPG, as well as liquid hydrocarbons, e.g., gasoline, diesel, alcohols, naphtha, residual oil, ethylene glycol, and glycerol. An appropriate operation condition (e.g., catalysts, temperature, fuel/oxidant ratio, and treatment process) is strongly dependent on the fuel quality, i.e., the number of carbons and the purity of each fuel. The use of a heavy hydrocarbon fuel with some impurities can easily suppress the reforming performance because of coke formation and catalyst poisoning. Although less carbon deposition is usually observed in autothermal reforming compared to steam reforming, significant amounts of carbon deposition are still widely reported in the autothermal reforming of propane, butane, and gasoline even under steam-rich conditions. Sulfur, even at small amounts, can significantly reduce the catalyst service life.

In the present invention, the process gas or reformed gas originated in the ATR can be used as heat source for partly reforming in a heat exchange reformer (HTER).

Blue Ammonia is ammonia that is created from using fossil fuel where at least 90% of the carbon in the fossil fuel is captured or recovered to be used in other products and processes or to be stored.

Carbon dioxide removal (CDR) methods cover either CO₂ capture (or recovery or removal) from the synthesis gas (pre-combustion carbon capture) as well as CO₂ capture (or recovery or removal) from the flue gas (post combustion carbon capture). In the present invention CDR refers to CO₂ capture (or recovery or removal) from the flue gas (post combustion carbon capture (or recovery or removal). Capture, recovery or removal of CO₂ is meant to mean the same in the present application.

Flash gas or process condensate means an intermediate gas stream obtained during CO₂ capture step.

Flue gas according to the present invention means a mixture of combustion products including water vapor, carbon dioxide, particulates, heavy metals, and acidic gases obtained from combustion of fuels in section (g). Part of or all flue gas from the reformer waste heat section (WHS) or fired heater(s) is further processed in a CDR.

Fuel section comprises fuel systems for supply of fuel to the combustion side of tubular reformers and/or fired heaters and/or auxiliary boilers and/or gas turbines. Preferably, the fuel section comprises at least one waste heat section (WHS) or comprises one or more fired heaters. These systems comprise one or more burners in which the incoming fuel streams are burned together with air at variable temperature and pressure.

Hydrocarbon feed is any suitable hydrocarbon for ammonia production, preferably natural gas or methane.

Make-up gas is the stream obtained from the purification unit, before entering the ammonia loop or ammonia synthesis section (f).

Methanation means that the purification step is the conversion of carbon monoxide and carbon dioxide (CO₂) to methane (CH₄) through hydrogenation. The methanation reactions (equations 1 and 2) are exothermic and at normal operating temperatures (250-350 °C) the equilibrium lies far to the right hand side.

CO+3H₂↔CH₄+H₂O (1)

CO₂+4H₂↔CH₄+2H₂O (2)

Using this route, the carbon monoxide and carbon dioxide impurities can be reduced to less than a few parts per million. The advantages of methanation, its simplicity and low cost, more than outweigh its disadvantages, hydrogen consumption and production of additional inerts in the makeup gas to the synthesis loop. Methanation can take place in a methanator or methanation section.

Nitrogen Wash or liquid nitrogen wash can be used as a final purification stage, delivering a gas to the ammonia synthesis loop that is free of all impurities, including inert gases. It is also the means for adding, in whole, or in part, the required nitrogen for ammonia synthesis. It is mainly used to purify and prepare ammonia synthesis gas within fertilizer plants. It is usually the last purification step upstream of ammonia synthesis. The liquid nitrogen wash has the function to remove residual impurities like CO, Ar and CH₄ from a crude hydrogen stream and to establish a stoichiometric ratio H₂/N₂ of approximately 3:1. Carbon monoxide must be completely removed, since it is poisonous for the ammonia synthesis catalyst. Ar and CH₄ are inert components enriching in the ammonia synthesis loop. If not removed, a syngas purge or expenditures for purge gas separation are required. Raw hydrogen (hydrogen rich process stream) and high pressure nitrogen are fed to the liquid nitrogen wash unit. Both streams are cooled down against product gas. Feeding raw hydrogen to the bottom of the nitrogen wash column and some condensed nitrogen liquid to the top. Trace components are removed and separated as fuel gas. To establish the desired H₂/N₂ ratio, high pressure nitrogen is added to the process stream. A nitrogen wash unit (NWU) is a unit or section where liquid nitrogen wash takes place.

Off-gases from one or more sections as the CO₂ capture section, the hydrogen purification section or the ammonia recovery section are used in the present invention as fuel, preferably in a primary reformer (FIG. 2a) or in an ATR (FIG. 2b).

PSA means pressure swing adsorption, enables the energy-efficient recovery of specific compounds from a gas under pressure.

When excess steam is available at a plant, a pre-reformer can be installed at the reformer section for lowering the steam production, reducing the primary reformer duty and hence gas consumption. While also reducing energy consumption, in general, the installation of a pre-reformer can reduce the size of the primary reformer by up to 25%. The technology can also be used to increase the production capacity at no additional energy costs. Installing a pre-reformer at an existing plant will typically increase production by 10-20%. Other benefits of the technology include the increased flexibility in terms of feedstock going to the steam reformer and the increased lifetime of the steam reformer and shift catalysts, as practically all sulphur in the hydrocarbon feed and process steam is absorbed by the pre-reforming catalyst.

Primary reformer is an energy absorbing unit requiring an external source of heat at elevated temperature. It is where by steam-hydrocarbons reforming reaction hydrogen is produced. Reforming reactions being endothermic in nature consume a large amount of energy. Approximately 80% of ammonia plant fuel consumption is at primary reformer burners. In the present invention the primary reformer is preferably a tubular reformer, e.g. an steam methane reformer (SMR).

Steam reforming is the key process in the formation of syngas for ammonia and methanol production. The reforming section is normally the largest, most expensive and most energy intensive piece of equipment on these plants and efficient and reliable operation is key to the performance of the whole plant. The reforming section comprises one or more reformers, arranged in series or in parallel. Optionally the reforming section may comprise a pre-reformer upstream to a primary reformer.

In steam methane reforming applications, the reforming furnace is a large piece of equipment and it has flue gas heat losses that have to be minimized through a complex waste heat recovery section. Therefore, there can be several alternative configurations developed that utilize a heat exchange reformer (HTER). These alternative approaches can be used to provide a reduced footprint and/or an alternative approach for debottlenecking existing facilities. In the present invention, an HTER, heat exchange convection reformer, can be arranged in series or in parallel with e.g. an autothermal reformer (ATR), with a tubular reformer (SMR), or with a two-step reforming configuration (e.g., an SMR followed by a secondary reformer) using the heat from the ATR or secondary reformer effluent. It is ideally suited for all synthesis gas production and in particular for hydrogen and ammonia production. It is a cost efficient option to revamp an existing plant to a larger capacity and for new plants, the technology offers a smaller footprint or even higher single line capacity and reduces flue gas amount.

A secondary reformer produces excess energy and can be, within the context of the present invention, an ATR, HTER or other. In general, the secondary reformer in the ammonia plant plays an important role in further converting methane from the primary reformer and supplying nitrogen by controlling the air flow rate, the optimum molar ratio of synthesis gas (CO+H₂) to nitrogen can be about 3.0.

The shift step is the reaction of synthesis gas with steam in a reaction zone to convert carbon monoxide into a raw gas mixture including carbon dioxide and hydrogen. At the outlet of steam reformers, in particular of an HTER, said syngas contains H₂, CO, CO₂, CH₄ and water in chemical equilibrium at high temperatures in the approximate range of 700 to 1040 °C depending on the process pressure and the mixture of feed stock and process steam or water. By means of the CO shift conversion an important portion of the CO content in the synthesis/process gas is used for additional hydrogen generation, which is following the chemical reaction

CO+H₂O<=>H₂+CO₂

This process is exothermic and is limited by the chemical equilibrium. There are three different versions of CO shift conversion: (i) High temperature (HT) CO shift conversion at about 320 to 450 °C down to approx. 3.5% CO on dry basis at the reactor outlet; (ii) Medium temperature (MT) CO shift conversion at about 190 to 330 °C down to approx. 0.8% CO on dry basis at the reactor outlet; and (iii) Low temperature (LT) CO shift conversion at about 180 to 230 °C down to approx. 0.3% CO on dry basis at the reactor outlet.

The application of the low temperature CO shift conversion is normally installed downstream of the HT shift at already reduced CO content in the feed gas. In the present invention the shift section (c) may comprise a high temperature shift, a medium temperature shift and/or a low-temperature shift and preferably the shift conversion is carried out in two stages, wherein a high temperature shift (HTS) catalyst is used as the first stage and typically converts over 80% of the CO, followed by use of a low temperature shift catalyst (LTS) that converts the majority of the remaining CO.

The process gas exiting the secondary reformer contains 12-15% (dry gas base) of CO (Two-step reforming layout). The process gas exiting the ATR contains 25-30% (dry gas base) of CO (SynCOR layout). In the shift section, most of the CO will be converted to CO₂. The performance of the shift conversion is very important for the overall efficiency of the ammonia plant, because unconverted CO will consume hydrogen (3*H2:1*CO) and form CH₄ in the methanator (Two-step reforming layout), reducing the feedstock efficiency and increasing the inert content in the synthesis loop. In SynCOR layout unconverted CO will end up in the off gas from the hydrogen purification step and impact on hydrogen production is less critical (1*H2:1*CO). Conventionally, the conversion reaction is conducted in two steps with heat removal steps in between. Initially, the process gas passes through a bed of iron oxide/chromium oxide catalyst at around 350-380 °C (High Temperature Shift conversion) in case of two-step reforming layout. In case of SynCOR layout the process gas passes through a catalyst bed of zinc aluminum spinel and zinc oxide in combination with an alkali metal selected from the group of Na, K, Rb, Cs and mixtures thereof, an optionally in combination with Cu at around 320-450 °C (High Temperature Shift conversion step). After the HTS step, in both layouts the process gas then passes over a copper oxide/zinc oxide catalyst at around 200-230 °C (Low Temperature Shift conversion). The outcome is process gas with a residual CO content of 0.2-0.5% (dry gas base). New developments can employ an isothermal shift one-step conversion. The process gas exiting the low temperature shift converter is cooled and after most of the steam is condensed and removed it passes through the CO₂ capture section. Heat released during cooling and condensation can be used for other purposes such as the regeneration of the CO₂ scrubbing unit.

Steam methane reforming (SMR) or tubular reforming means a process in which methane from natural gas is heated, with steam, usually with a catalyst, to produce a mixture of carbon monoxide and hydrogen used in organic synthesis and as a fuel. In energy industry, SMR is one of the most widely used process for the generation of hydrogen.

Two-step reforming features a combination of tubular reforming (primary reforming) and oxygen-fired autothermal reforming (ATR) (secondary reforming). Two-step reforming produces a process gas or reformed gas. In the present invention, said process gas can be further reformed in a heat exchange reformer (HTER), becoming a three-step reforming layout and when a pre-reformer is used it becomes a four-step reforming layout.

### PREFERRED EMBODIMENTS

1. Process for producing ammonia comprising the steps of:
i) preheating a hydrocarbon feed;
ii) removing sulphur and other contaminants from the preheated hydrocarbon feed;
iii) reforming the preheated hydrocarbon feed and obtaining a synthesis gas comprising CO, CO₂, H₂, H₂O and CH₄;
iv) sending the synthesis gas through a shift reaction step reducing the CO content;
v) sending the CO depleted synthesis gas to a CO₂ capture step where it is split in at least a CO₂ rich stream and a hydrogen rich stream and optionally into a flash gas stream;
vi) sending the hydrogen rich stream through a purification step;
vii) sending a part of the synthesis gas stream obtained in the previous step through an ammonia synthesis section, where it is converted to ammonia and optionally another part of said synthesis gas stream to the fuel section;
wherein the reforming step comprises heat exchange reforming (HTER); and
   At least part of the heat in the synthesis gas from the reforming step (secondary reformer or autothermal reformer) is used in the heat exchange reforming step,
   At least 80% wt of CO₂ is captured from the flue gas and
   Up to at least 98% wt of overall CO₂ is captured.

Up to at least 98 wt % CO₂ overall can be captured with flue gas CDR (applicable for all layouts).

At least 80% of CO₂ is captured for all layouts, however for two step reforming layout with or without HTER-p or -s, more CO₂ may be captured from the flue gas with CDR than when compared with the SynCOR layout.
2. Process according to embodiment 1 wherein one or more carbon containing off gas stream(s) are sent to the fuel section (g).
2.1 Process according to embodiment 1 wherein one or more carbon containing off gas stream(s) are sent to the reforming section (b). This may reduce the size of the required flue gas carbon capture unit.
3. Process according to any one of embodiments 1 to 2 wherein CO₂ in the flue gas coming from the reforming waste heat section and/or the fired heater(s) is captured by CDR unit(s).
4. Process according to any one of embodiments 1 or 3 wherein at least part of the hydrocarbon feed undergoes two-step reforming and another part heat exchange reforming.
5. Process according to any one of embodiments 1 to 4, wherein at least part of the hydrocarbon feed undergoes primary reforming, air blown secondary reforming step and heat exchange reforming.
5.1. Process according to the previous embodiment, wherein the amount of air to the air blown secondary reformer is adjusted to obtain a molar ratio of N₂ and H₂ between 1 to 2.5 and 1 to 3.5, in the stream from the methanation step.
6. Process according to any one of embodiments 1 to 5 wherein the secondary reforming step is followed by heat exchange reforming and at least part of the heat generated in the secondary reformer is used in the HTER.
6.1 Process according to any one of embodiments 1 to 5 wherein the heat exchange reforming step is followed by secondary reforming and at least part of the heat generated in the secondary reformer is used in the HTER.
6.2 Process according to any one of embodiments 1 to 5, wherein at least part of the hydrocarbon feed is directed to an HTER.
6.3 Process according to any of the preceding embodiments wherein the preheated and desulfurized hydrocarbon outlet stream is split into a stream directed to a heat exchange reformer and another stream directed to a pre-reformer (b0) or a primary reformer or an autothermal reformer.
7. Process according to any one of embodiments 1 to 6 wherein the purification step is methanation where the CO and CO₂ together with hydrogen are converted into CH₄ and H₂O, to obtain a synthesis gas stream, comprising nitrogen and hydrogen.
7.1 Process according to the previous embodiments wherein a purge gas stream, comprising the CH₄ from the ammonia synthesis, is added to the obtained synthesis gas.
8. Process according to any one of embodiments 1 to 3 wherein at least part of said hydrocarbon feed undergoes autothermal reforming and heat exchange reforming.
9. Process according to any one of embodiments 1 to 3 and 8 wherein the autothermal reforming step is followed by heat exchange reforming and at least part of the heat generated in the ATR is used in the HTER.
9.1 Process according to embodiment 8 wherein the heat exchange reforming step is followed by autothermal reforming and at least part of the heat generated in the ATR is used in the HTER.
10. Process according to any one of embodiments 1, 3 and 8 wherein the purification step is a hydrogen purification or nitrogen wash step, where H₂O, CO, CO₂, CH₄ are removed in an off-gas stream and a purified hydrogen stream is obtained, wherein nitrogen is added to obtain an ammonia synthesis gas stream comprising nitrogen and hydrogen.
10.1 Process according to the previous embodiment wherein the purification step is a PSA step, obtaining a hydrogen stream comprising more than 99.5% vol. hydrogen, to which nitrogen is added, obtaining a synthesis gas stream comprising nitrogen and hydrogen and an off-gas stream.
11. Process according to any of the preceding embodiments comprising a pre-reforming step of the hydrocarbon feed.
12. Process according to any one of the preceding embodiments wherein a synthesis gas stream is derived from the purification step and used as fuel.
13. Process according to any one of the preceding embodiments wherein a make-up gas stream comprising N₂ and H₂ is derived downstream to the purification step and is used as fuel.
13.1 Process according to the previous embodiment, wherein the make-up gas stream obtained from the purification step comprises N₂ and H₂ in a ratio of 1 to between 2.9 and 3.1.
14. Process according to any one of the preceding embodiments wherein at least part of a hydrocarbon feed, at least part of a flash gas from CO₂ capture step, at least part of the off gas or synthesis gas from purification step, at least part of the make-up gas derived downstream to the purification step and at least part of the off gas from the ammonia recovery section are either premixed or fed separately to the fuel section (g) to be used as fuel.
15. Plant for producing ammonia according to the process in embodiments 1 to 14, comprising:
   I. a preheating section (not shown)
   II. a desulfurization section (a)
   III. a reforming section (b);
   IV. a shift section (c);
   V. a CO₂ capture section (d);
   VI. a purification section (e);
   VII. an ammonia synthesis section (f) (not shown); and
   VIII. a fuel section (g) (not shown), wherein said reforming section (b) is connected to a heat exchange reformer (HTER).
16. Plant according to embodiment 15, wherein said fuel section comprises a reforming waste heat section or one or more fired heaters equipped with a CDR unit for capturing CO₂ from the flue gas.
17. Plant according to any one of embodiments 15 and 16, wherein the reforming section is arranged downstream to a pre-reformer (b0), such as an adiabatic pre-reformer.
18. Plant according to any one of embodiments 15 to 17 wherein the purification section (e) comprises a nitrogen wash unit (NWU) or a pressure swing adsorption (PSA) unit or a methanator.
19. Plant according to any one of embodiments 15 to 18 wherein the reforming section comprises a primary reformer and a secondary reformer, associated to an HTER.
20. Plant according to any one of embodiments 15 to 19 wherein the HTER is arranged in parallel with the reforming section, downstream to the secondary reformer.
20.1 Plant according to any one of embodiments 15 to 19 wherein the HTER is arranged in series with the reforming section, upstream to the secondary reformer.
21. Plant according to any one of embodiments 15 to 20 wherein the reforming section comprises an air blown secondary reformer, arranged downstream to the primary reformer.
21.1 Plant according to any one of embodiments 15 to 21, wherein the purification unit is a methanator.
21.2 Plant according to any one of embodiments 15 to 22, wherein the fuel section (g) comprises one or more waste heated section(s).
21.3 Plant according to any one of embodiments 15 to 23 wherein the reforming section is a two-step reforming section associated to an HTER, the purification unit is a methanator unit and the fuel section comprises one or more waste heat section(s), equipped with one or more CDR units.
21.4 Plant according to the previous embodiment wherein the two-step reforming section comprises a primary reformer (b1), preferably a tubular steam reformer such as an SMR and a secondary reformer (b2), such as an ATR or other.
22. Plant according to any one of embodiments 15 to 18 wherein the reforming section comprises an ATR, associated to an HTER.
22.1 Plant according to any one of embodiments 15 to 18 and 22 wherein the HTER is arranged in parallel with the reforming section, downstream to the ATR.
22.2 Plant according to any one of embodiments 15 to 18 and 22 to 23 wherein the HTER is arranged in series with the reforming section, upstream to the ATR.
22.3 Plant according to any one of embodiments 15 to 18 and 22 to 24 wherein the purification unit is a NWU or a PSA.
22.4 Plant according to any one of embodiments 15 to 18 and 22 to 25 wherein the fuel section comprises one or more fired heaters.
22.5 Plant according to any one of the embodiments 15 to 18 and 22 to 26 wherein when an ATR is used, either as secondary reformer in a two-step reforming section or as a single step reformer, the purification unit is preferably a NWU or a PSA and the fuel section comprises one or more fired heaters, equipped with one or more CDR unit(s).

### BRIEF DESCRIPTION OF DRAWINGS

FIG. 1a) shows an example for an overview for producing ammonia according to DK PA 2022 00424, using a steam reformer followed by an autothermal reformer in the synthesis gas generation:
a) Desulphurization
b) Pre-reforming
b) Reforming (SMR)
b) Reforming (ATR)
c) Shift section
d) CO₂ capture section
e) Purification section (e.g. methanation unit)
f) Ammonia synthesis section
g) Fuel section (e.g. one or more waste heat section(s)) including flue gas CDR unit (not shown)
i) Ammonia recovery section, optionally including a hydrogen recovery unit (HRU)

FIG. 1b) shows an alternative to FIG. 1a), but comprising an NWU or PSA as purification unit and one or more fired heaters in the fuel section including a CDR unit (not shown) for capturing CO₂ from part of or all the flue gas.

FIG. 2 shows two preferred embodiments of the present invention with a) two-step reforming or b) ATR, in connection with an HTER (three-step reforming) in the reforming section (b).

FIG. 3 shows a third preferred embodiment where said three-step reforming makes use of enriched air.

All three embodiments shown in FIGS. 2 and 3 comprise the (not shown) sections of hydrocarbon (HC) feeding, ammonia synthesis (f) and fuel section (g), as well as the (also not shown) interactions, as represented in FIGS. 1a) and 1b).

FIG. 4 shows when 3-step reforming layout, including HTER becomes attractive with respect to NG and power prices, for example when the values in the following Table 1 apply as basis and then either natural gas or power price is varied:

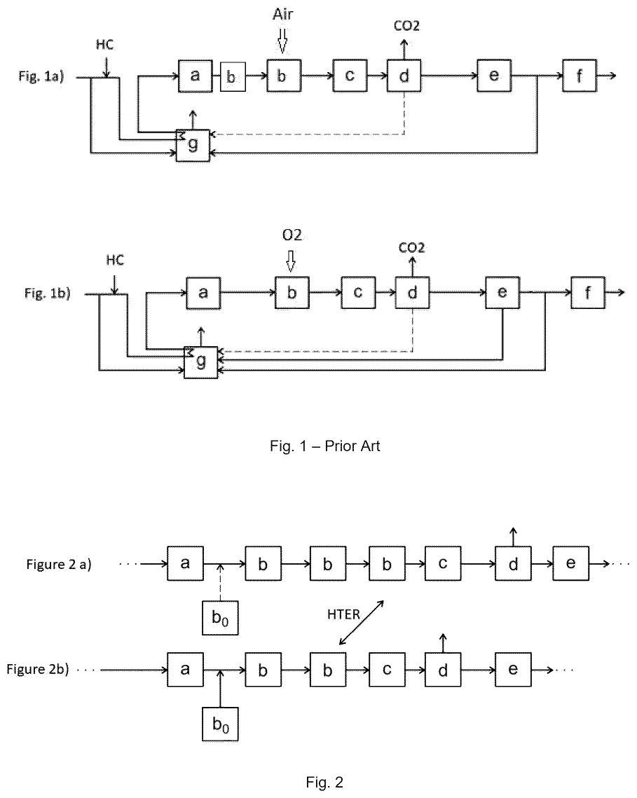

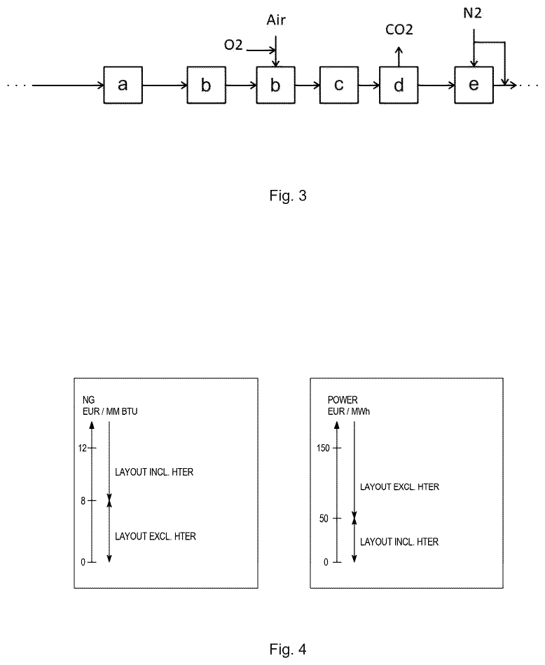

| Utility | Unit | Base price |
|---|---|---|
| Natural gas | €/MMBTU | 4 |
| Power | €/MWh | 100 |
| DMW | €/m³ | 1 |
| Steam | €/ton | 13.5 |
| CO₂ credit for carbon captured | €/ton | 25 |

### EXAMPLE 1

Table 2 shows the benefits of the proposed layout, in terms of carbon capture or recovery (%).

Traditional ammonia production involves utilization of off gases from ammonia recovery and syngas preparation steps to supplement natural gas as main fuels for fired heater/process furnaces. This would result in carbon emissions from flue gas stack of 65-71% for two step reforming layout without or with HTER. With the layout disclosed in document DK PA 2022 00424, including a CDR unit for flue gas carbon capturing this results in significant carbon emission reduction, up to more than 98% capture or recovery can be obtained.

Advantageously, the present invention provides the layout in the last column to the right in Table 2, showing that a smaller flue gas carbon capture unit, CCU/CDR is required with a layout including HTER (FIG. 2a), when compared to a conventional 2-step layout including CDR.

TABLE 2

| | | | | | 3-step |
|---|---|---|---|---|---|
| | | | 2-step | 3-step | re- |
| | | | re- | re- | forming |
| | | 2-step | forming | forming | incl. |
| | | re- | incl. | incl. | HTER + |
| | Unit | forming | CDR | HTER | CDR |
| Ammonia production | MTPD | 3000 | 3000 | 3000 | 3000 |
| CO₂ in emitted flue | Nm³/h | 41612 | 2354 | 30741 | 2137 |
| gas | | | | | |
| CO₂ as 100%, | Nm³/h | 76109 | 76109 | 76164 | 76164 |
| captured in process | | | | | |
| CO₂ as 100%, | Nm³/h | 0 | 39260 | 0 | 28579 |
| captured in flue | | | | | |
| gas CDR | | | | | |
| Total CO₂ as 100%, | Nm³/h | 76109 | 115369 | 76164 | 104743 |
| captured for | | | | | |
| storage/utilization | | | | | |
| Carbon capture or | % | 65 | 98 | 71 | 98 |
| recovery, approx. | | | | | |

1. A process for producing ammonia comprising the steps of:
i) preheating a hydrocarbon feed;
ii) removing sulphur and other contaminants from the preheated hydrocarbon feed;
iii) reforming the preheated hydrocarbon feed and obtaining a synthesis gas comprising CO, CO₂, H₂, H₂O, and CH₄;
iv) sending the synthesis gas through a shift reaction step reducing the CO content;
v) sending the CO depleted synthesis gas to a CO₂ capture step where it is split in at least a CO₂ rich stream and a hydrogen rich stream and optionally into a flash gas stream;
vi) sending the hydrogen rich stream through a purification step; and
vii) sending a part of the synthesis gas stream obtained in the previous step through an ammonia synthesis section, where it is converted to ammonia and optionally another part of said synthesis gas stream to the fuel section,
wherein:
the reforming step comprises heat exchange reforming (HTER);
at least part of the heat in the synthesis gas from the reforming step is used in the heat exchange reforming step;
at least 80% wt of CO₂ is captured from the flue gas; and
up to at least 98% wt of overall CO₂ is captured.

2. The process according to claim 1, wherein one or more carbon containing off gas stream(s) are sent to the fuel section.

3. The process according to claim 1, wherein CO2 in the flue gas coming from the reforming waste heat section and/or the fired heater(s) is captured by CDR unit(s).

4. The process according to claim 1, wherein at least part of the hydrocarbon feed undergoes two-step reforming and another part heat exchange reforming.

5. The process according to claim 1, wherein at least part of the hydrocarbon feed undergoes primary reforming, air blown secondary reforming step and heat exchange reforming.

6. The process according to claim 1, wherein the secondary reforming step is followed by heat exchange reforming and at least part of the heat generated in the secondary reformer is used in the HTER.

7. The process according to claim 1, wherein the purification step is methanation where the CO and CO₂ together with hydrogen are converted into CH₄ and H₂O, to obtain a synthesis gas stream, comprising nitrogen and hydrogen.

8. The process according to claim 1, wherein at least part of said hydrocarbon feed undergoes autothermal reforming and heat exchange reforming.

9. The process according to claim 1, wherein the autothermal reforming step is followed by heat exchange reforming and at least part of the heat generated in the ATR is used in the HTER.

10. The process according to claim 1, wherein the purification step is a hydrogen purification or nitrogen wash step, where H₂O, CO, CO₂, CH₄ are removed in an off-gas stream and a purified hydrogen stream is obtained, wherein nitrogen is added to obtain an ammonia synthesis gas stream comprising nitrogen and hydrogen.

11. The process according to claim 1, comprising a pre-reforming step of the hydrocarbon feed.

12. The process according to claim 1, wherein a synthesis gas stream is derived from the purification step and used as fuel.

13. The process_according to claim 1, wherein a make-up gas stream comprising N₂ and H₂ is derived downstream to the purification step and is used as fuel.

14. The process according to claim 1, wherein at least part of a hydrocarbon feed, at least part of a flash gas from CO₂ capture step, at least part of the off gas or synthesis gas from purification step, at least part of the make-up gas derived downstream to the purification step and at least part of the off gas from the ammonia recovery section are either premixed or fed separately to the fuel section (g) to be used as fuel.

15. A plant for producing ammonia according to the process in claim 1, comprising:
I. a preheating section;
II. a desulfurization section;
III. a reforming section;
IV. a shift section;
V. a CO₂ capture section;
VI. a purification section;
VII. an ammonia synthesis section; and
VIII. a fuel section,
wherein said reforming section is connected to a heat exchange reformer (HTER).

16. The plant according to claim 15, wherein said fuel section comprises a reforming waste heat section or one or more fired heaters equipped with a CDR unit for capturing CO₂ from the flue gas.

17. The plant according to claim 15, wherein the reforming section is arranged downstream to a pre-reformer.

18. The plant according to claim 15, wherein the purification section (e) comprises a nitrogen wash unit (NWU) or a pressure swing adsorption (PSA) unit or a methanator.

19. The plant according to claim 15, wherein the reforming section comprises a primary reformer and a secondary reformer, associated to an HTER.

20. The plant according to claim 15, wherein the HTER is arranged in parallel with the reforming section, downstream to the secondary reformer.

21. The plant according to claim 15, wherein the reforming section comprises an air blown secondary reformer, arranged downstream to the primary reformer.

22. The plant according to claim 15, wherein the reforming section comprises an ATR, associated to an HTER.
